(19) United States
(12) Patent Application Publication
(10) Pub. No.: US 2021/0209955 A1
(43) Pub. Date: Jul. 8, 2021

(54) INFORMATION PROCESSING METHOD, AIRCRAFT, SYSTEM, AND STORAGE MEDIUM

(71) Applicant: SZ DJI TECHNOLOGY CO., LTD., Shenzhen (CN)

(72) Inventors: Wei FAN, Shenzhen (CN); Xiaodong WANG, Shenzhen (CN)

(21) Appl. No.: 17/211,317

(22) Filed: Mar. 24, 2021

Related U.S. Application Data
(63) Continuation of application No. PCT/CN2018/112793, filed on Oct. 30, 2018.

(30) Foreign Application Priority Data
Sep. 29, 2018 (CN) PCT/CN2018/108863

(51) Int. Cl. G08G 5/00; G06K 9/00

(52) U.S. Cl. CPC G08G 5/0073; G08G 5/0008; G06K 9/0063

(57) ABSTRACT

An information processing method includes receiving one or more pieces of automatic dependent surveillance-broadcast (ADS-B) information each broadcast by one of one or more first aircrafts, parsing the one or more pieces of ADS-B information to obtain one or more pieces of parsed location information and one or more pieces of parsed time information, and determining current time information of a second aircraft according to the one or more pieces of parsed location information and the one or more pieces of parsed time information. Each of the one or more pieces of parsed location information and each of the one or more pieces of parsed time information correspond to one of the one or more first aircrafts.

### CROSS-REFERENCE TO RELATED APPLICATIONS

This application is a continuation of International Application No. PCT/CN2018/112793, filed Oct. 30, 2018, which claims priority to International Application No. PCT/CN2018/108863, filed Sep. 29, 2018, the entire contents of both of which are incorporated herein by reference.

### TECHNICAL FIELD

The present disclosure generally relates to the information processing technology field and, more particularly, to an information processing method, an aircraft, a system, and a storage medium.

### BACKGROUND

With the development of flight technology, aircraft has become a popular research topic and is widely applied to fields of plant protection, aerial photography, and forest fire alarm monitoring. Various industries have increasingly higher requirements for accuracy of aircraft positioning. Time information of an aircraft is one of key parameters that affect positioning of the aircraft. In practical applications, time information is mainly transmitted to the aircraft by a ground mobile terminal. The aircraft receives and uses the time information as its time information. Since a certain time is needed for transmitting the time information, the time information of the aircraft is not accurate. Thus, the aircraft positioning is not accurate. Therefore, how to obtain the accurate time information of the aircraft needs to be solved.

### SUMMARY

Embodiments of the present disclosure provide an information processing method. The method includes receiving one or more pieces of automatic dependent surveillance-broadcast (ADS-B) information each broadcast by one of one or more first aircrafts, parsing the one or more pieces of ADS-B information to obtain one or more pieces of parsed location information and one or more pieces of parsed time information, and determining current time information of a second aircraft according to the one or more pieces of parsed location information and the one or more pieces of parsed time information. Each of the one or more pieces of parsed location information and each of the one or more pieces of parsed time information correspond to one of the one or more first aircrafts.

Embodiments of the present disclosure provide an aircraft including a vehicle body, a propulsion system, a camera device, and a processor. The propulsion system is arranged at the vehicle body and configured to provide flight power. The camera device is arranged at the vehicle body and configured to perform at least one of photographing or video recording. The processor is configured to receive one or more pieces of automatic dependent surveillance-broadcast (ADS-B) information each broadcast by one of one or more reference aircrafts, parse the one or more pieces of ADS-B information to obtain one or more pieces of parsed location information and one or more pieces of parsed time information, and determine current time information of the aircraft according to the one or more pieces of parsed location information and the one or more pieces of parsed time information. Each of the one or more pieces of parsed location information and each of the one or more pieces of parsed time information correspond to one of the one or more reference aircrafts.

Embodiments of the present disclosure provide an aircraft system including one or more first aircrafts and a second aircraft. The one or more first aircrafts are configured to generate and broadcast one or more pieces of automatic dependent surveillance-broadcast (ADS-B) information each from one of the one or more first aircrafts. The second aircraft is configured to receive the one or more pieces of ADS-B, parse the one or more pieces of ADS-B information to obtain one or more pieces of parsed location information and one or more pieces of parsed time information, and determine current time information of a second aircraft according to the one or more pieces of parsed location information and the one or more pieces of parsed time information. Each of the one or more pieces of parsed location information and each of the one or more pieces of parsed time information correspond to one of the one or more first aircrafts.

### BRIEF DESCRIPTION OF THE DRAWINGS

FIG. 1 is a schematic structural diagram of an aircraft system according to some embodiments of the present disclosure.

FIG. 2 is a schematic flowchart of an information processing method according to some embodiments of the present disclosure.

FIG. 3 is a schematic flowchart of another information processing method according to some embodiments of the present disclosure.

FIG. 4 is a schematic flowchart of another information processing method according to some embodiments of the present disclosure.

FIG. 5 is a schematic structural diagram of an aircraft according to some embodiments of the present disclosure.

### DETAILED DESCRIPTION OF THE EMBODIMENTS

In connection with the accompanying drawings, embodiments of the present disclosure are described in detail. When there is no conflict, embodiments and features of embodiments may be combined with each other.

A global navigation satellite system (GNSS) is a radio wave navigation and positioning system that is omnipotence (land, sea, aviation, and aerospace), all-weather, continuous, and in real-time. The GNSS can provide highly accurate navigation or positioning. Therefore, during a flight of an aircraft, a satellite navigation system may be configured to perform navigation and/or positioning for the aircraft. A principle of the aircraft using the satellite navigation system to perform navigation includes determining a satellite visible to the aircraft according to current time information and current location information (rough location information) of the aircraft, and satellite almanac, which is used to record location information of a satellite; receiving a satellite signal transmitted by the visible satellite; and realizing positioning and/or navigation according to the satellite signal and the current location information of the aircraft. A visible satellite refers to a satellite having a signal coverage range located within a range in which the aircraft can receive a signal. That is, the aircraft can only receive the satellite signal transmitted by the visible satellite. Since the current time information of the aircraft is not accurate enough, the determined visible satellite may not be accurate, which may cause the aircraft to be not able to receive a satellite signal, and hence the aircraft may need to spend a long time to search in the sky for the visible satellite again. Since the aircraft is in a moving state, the current location information of the aircraft is changing, which may cause a low accuracy in positioning and/or navigation. Thus, the accuracy of the current time information of the aircraft may directly affect the accuracy of the navigation and/or positioning of the aircraft. Therefore, the current time information of the aircraft is one of the key parameters that affect the navigation and/or positioning of the aircraft.

In the existing technology, the current time information may be obtained for the aircraft through a ground terminal. Since the terminal is far away from the aircraft, the obtained time information may not be accurate. Embodiments of the present disclosure provide an information processing method. The method includes the following processes. A second aircraft may receive automatic dependent surveillance-broadcast (ADS-B) information broadcast by each of a plurality of first aircrafts. Each piece of ADS-B information may be parsed to obtain location information and time information included in each piece of ADS-B information. The current time information of the second aircraft may be determined according to the location information and the time information included in each piece of ADS-B information. The current time information of the second aircraft may be used to indicate the time when the second aircraft receives ADS-B information. Thus, in some embodiments, the current time information of the second aircraft may be determined based on the location information and the time information included in the ADS-B information. The time information transmitted by the ground terminal may not be directly used as the current time information of the second aircraft. As such, the accuracy of the time information of the second aircraft may be improved. Further, according to the time information of the second aircraft, satellite search may be quickly performed, where satellite search refers to searching for satellite(s) visible to the second aircraft.

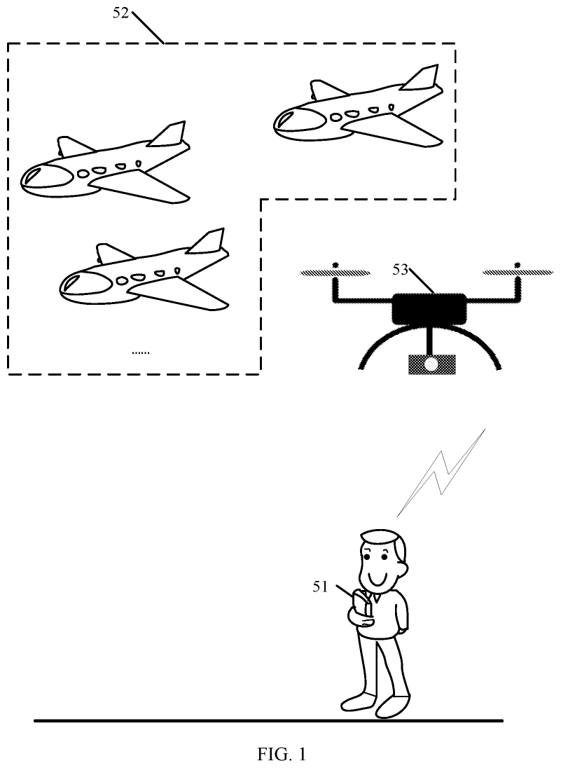

To facilitate understanding of the information processing method of the present disclosure, embodiments of the present disclosure further provide an aircraft system. The aircraft system shown in FIG. 1 is described.

FIG. 1 is a schematic structural diagram of the aircraft system according to some embodiments of the present disclosure. The aircraft system includes a control apparatus 51, a plurality of first aircrafts 52 (also referred to as “reference aircrafts”), and a second aircraft 53. The control apparatus 51 may be a control terminal of the second aircraft 53 and may include one or more of a remote controller, a smartphone, a tablet, a laptop, a ground station, and a wearable device (a watch, a wristband). The second aircraft 53 may include an unmanned aerial vehicle (UAV), for example, a rotor UAV, such as a four-rotor UAV, a six-rotor UAV, or an eight-rotor UAV, or a fixed-wing UAV. The UAV may include a propulsion system. The propulsion system may be configured to provide flight power for the UAV. The propulsion system may include one or more of a propeller, a motor, and an electrical speed controller (ESC). The UAV may further include a gimbal and a camera device. The camera device may be carried at a vehicle body through the gimbal. The camera device may be configured to perform photographing or video recording during the flight of the UAV. The camera device may include but is not limited to a multispectral imager, a hyperspectral imager, a visible light camera, an infrared camera, etc. The gimbal may be a multi-axis transmission and stabilization system. A motor of the gimbal may compensate for a photographing angle of the camera device by adjusting a rotation angle of a rotation axis. The vibration of the camera device may be prevented or reduced by setting a suitable buffer mechanism. The first aircraft 52 may include an airplane, which may be configured to provide information to the second aircraft 53 and transfer guests, mails, or goods.

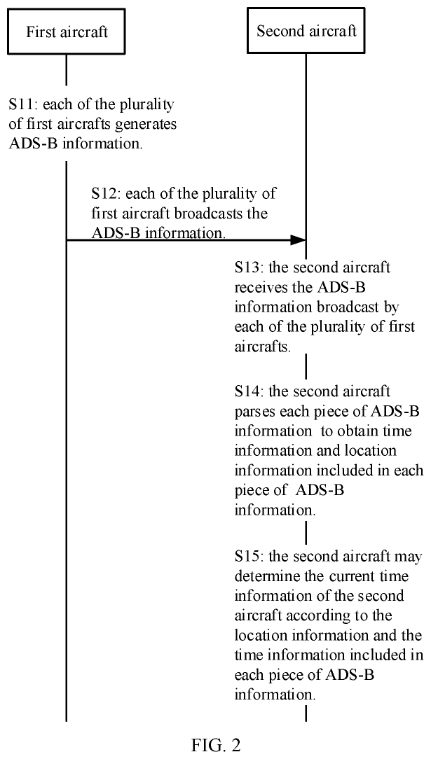

In some embodiments, the aircraft system may be configured to realize an information processing method of embodiments of the present disclosure. As shown in FIG. 2, the method includes the following processes.

At S11, each of the plurality of first aircrafts generates ADS-B information.

Each first aircraft may encrypt time information and location information according to a predetermined encryption algorithm to obtain the ADS-B information to avoid broadcast information from being modified. In some embodiments, each first aircraft may encode the time information and location information according to a predetermined encoding manner to obtain the ADS-B information to improve information transmission efficiency.

The predetermined encryption algorithm may include advanced encryption standard (AES), data encryption standard (DES), secure hash algorithm (SHA), message digest 5 (MD5), etc. The predetermined encoding algorithm may include Manchester encoding or differential Manchester encoding, etc.

At S12, each of the plurality of first aircrafts broadcasts the ADS-B information.

Each of the plurality of first aircrafts may broadcast its ADS-B information according to a predetermined time cycle, or each of the plurality of first aircrafts may broadcast its own ADS-B information when arriving at a determined location or at a determined moment. For example, the determined location may include a location where the first aircraft is located when the first aircraft detects that the distance to the second aircraft is smaller than a predetermined distance.

At S13, the second aircraft receives the ADS-B information broadcast by each of the plurality of first aircrafts.

At S14, the second aircraft parses each piece of ADS-B information to obtain time information and location information included in each piece of ADS-B information.

The time information included in the ADS-B information may be used to indicate the time when the ADS-B information is transmitted. The location information included in the ADS-B information may be used to indicate the current location of the corresponding first aircraft when the ADS-B information is transmitted.

At S15, the second aircraft may determine the current time information of the second aircraft according to the location information and the time information included in each piece of ADS-B information.

In processes S13 to S15, the second aircraft may receive the ADS-B information broadcast by each of the plurality of first aircrafts. The second aircraft may perform decryption or decoding on each piece of ADS-B information to obtain the time information and the location information included in each piece of ADS-B information. the second aircraft may further determine the current time information of the second aircraft according to the location information and the time information included in each piece of ADS-B information.

In some embodiments, by parsing the ADS-B information broadcast by each of the plurality of first aircrafts, the time information and the location information included in each piece of ADS-B information may be obtained. The current time information of the second aircraft may be determined according to the time information and the location information included in each piece of ADS-B information. Thus, in embodiments of the present disclosure, the current time information of the second aircraft may be determined based on the time information and the location information included in the ADS-B information transmitted by the first aircraft. The time information transmitted by the ground terminal may not be directly used as the current time information of the second aircraft, which improves the accuracy of obtaining the time information of the second aircraft. In addition, a distance between the second aircraft and a first aircraft may be smaller than a distance between the second aircraft and the ground terminal. The accuracy of obtaining the time information of the second aircraft may be further improved. Thus, satellite search may be quickly performed according to the time information of the second aircraft.

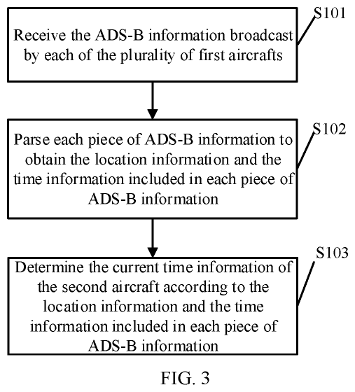

FIG. 3 is a schematic flowchart of another information processing method according to some embodiments of the present disclosure. The method may be executed by the second aircraft. The second aircraft is described above. A difference between FIG. 3 and FIG. 2 is that, FIG. 2 describes the interaction between the first aircrafts and the second aircraft for determining the current time information of the second aircraft based on the ADS-B information, while FIG. 3 describes a method performed by the second aircraft for determining the current time information of the second aircraft based on the ADS-B information. As shown in FIG. 3, the information processing method includes the following processes.

At S101, the ADS-B information broadcast by each of the plurality of first aircrafts is received.

In some embodiments, in a scene that the current time information of the second aircraft needs to be obtained, the second aircraft may receive the ADS-B information broadcast by each of the plurality of first aircrafts.

At S102, each piece of ADS-B information is parsed to obtain the location information and the time information included in each piece of ADS-B information.

In some embodiments, the ADS-B information may be obtained by the first aircraft performing encryption on the time information and the location information according to the predetermined encryption algorithm. The second aircraft may perform decryption on each piece of ADS-B information according to a decryption algorithm corresponding to the encryption algorithm to obtain the location information and the time information included in each piece of ADS-B information. The ADS-B information may be obtained by the first aircraft performing encoding on the time information and the location information according to a predetermined encoding algorithm. The second aircraft may perform decoding on each piece of ADS-B information according to the decoding algorithm corresponding to the predetermined encoding algorithm to obtain the location information and the time information included in each piece of ADS-B information.

At S103, the current time information of the second aircraft is determined according to the location information and the time information included in each piece of ADS-B information.

In some embodiments, the second aircraft may determine the current time information of the second aircraft according to the location information and the second information included in each piece of ADS-B information. In some embodiments, the second aircraft may determine the current location information of the second aircraft according to the location information included in each piece of ADS-B information. The second aircraft may determine the current time information of the second aircraft according to the current location information of the second aircraft and the time information included in each piece of ADS-B information.

The location information may include a location coordinate value (such as a coordinate value in a geodetic coordinate system). An average coordinate value of location coordinate values included in ADS-B information broadcast by the plurality of first aircrafts. The average coordinate value may be used as a coordinate value of the current location of the second aircraft. The average value may be used to indicate the current location of the second aircraft. In some embodiments, the location information may include longitude and latitude of the location. The longitude and latitude of the location included in the ADS-B information broadcast by each first aircraft may be converted into a coordinate value in the geodetic coordinate system. The coordinate value of the second aircraft may be calculated according to each coordinate value obtained by conversion. The coordinate value of the second aircraft may be used to indicate the current location of the second aircraft.

In some embodiments, the time information and the location information included in each piece of ADS-B information may be obtained by parsing the ADS-B information of each of the plurality of first aircrafts. The current time information of the second aircraft may be determined according to the time information and the location information included in each piece of ADS-B information. Thus, in embodiments of the present disclosure, the current time information of the second aircraft may be determined based on the time information and the location information included in the ADS-B information transmitted by the first aircraft. That is, the current location of the second aircraft may be determined according to the location information included in the ADS-B information. The distance between the second aircraft and the first aircraft may be determined according to the current location information of the second aircraft and the location information included in the ADS-B information. A time delay of transmitting the ADS-B information from the first aircraft to the second aircraft may be determined according to the distance. The current time information of the second aircraft may be determined according to the time delay (i.e., transmission time length) and the time information included in the ADS-B information. That is, the current time information of the second aircraft may take into account the time delay of transmitting the ADS-B information from the first aircraft to the second aircraft rather than directly use the time information transmitted by the ground terminal (or the first aircraft) as the current time information of the second aircraft. Thus, the accuracy of obtaining the time information of the second aircraft may be improved. In addition, the distance between the second aircraft and the first aircraft may be much smaller than the distance between the second aircraft and the ground terminal, which further improves the accuracy of obtaining the time information of the second aircraft. Thus, the satellite may be searched quickly according to the time information of the second aircraft.

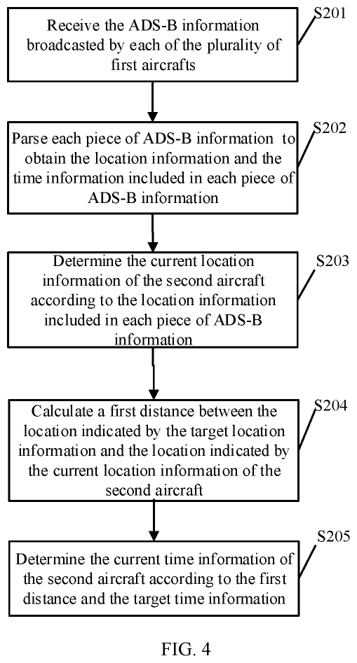

FIG. 4 is a schematic flowchart of another information processing method according to some embodiments of the present disclosure. The method may be applied by the second aircraft. The second aircraft is described above. The difference between FIG. 4 and FIG. 3 includes determining the current location information of the second aircraft according to the location information included in each piece of ADS-B information, calculating a first distance between a location indicated by target location information and a location indicated by the current location information of the second aircraft, and determining the current time information of the second aircraft according to the first distance and the target time information. As shown in FIG. 4, the information processing method includes receiving the ADS-B information broadcast by each of the plurality of first aircrafts (S201), parsing each piece of ADS-B information to obtain the location information and the time information included in each piece of ADS-B information (S202), and determining the current location information of the second aircraft according to the location information included in each piece of ADS-B information (S203).

In some embodiments, the second aircraft may determine the current location information of the second aircraft according to the location information included in each piece of ADS-B information. Thus, the time information of the second aircraft may be determined according to the current location information of the second aircraft.

In some embodiments, the current location information of the second aircraft may include a predetermined coordinate of a location where the second aircraft is currently located. Process S203 includes calculating a second distance between a position indicated by the location information included in one piece of ADS-B information and the predetermined coordinate, calculating a sum of the second distances, and determining a value of the predetermined coordinate when a value of the sum is smallest. The predetermined coordinate may be used to indicate the position where the second aircraft is currently located.

The second aircraft may have a larger probability of receiving ADS-B information of the plurality of first aircrafts at a center of gravity of a figure formed by the plurality of first aircrafts as compared to a location other than the center of gravity of the figure formed by the plurality of first aircrafts. Thus, the location of the second aircraft may be determined according to the center of gravity of the figure formed by the plurality of first aircrafts. In some embodiments, the second aircraft may calculate the second distance between the location indicated by the location information included in each piece of ADS-B information and the predetermined coordinate, calculate the sum of the second distances, and determine the value of the predetermined coordinate when the value of the sum is the smallest. The value of the coordinate may be used to indicate the location where the second aircraft is currently located. The value of the coordinate may further be used to indicate the location of the center of gravity of the figure formed by the plurality of first aircrafts.

For example, assume that the predetermined coordinate of the second aircraft is (x, y, z). The plurality of first aircrafts may include three first aircrafts, which are identified as aircraft A, aircraft B, and aircraft C. A distance between a location indicated by location information included in ADS-B information broadcast by aircraft A and the predetermined coordinate may be determined as d1. A distance between a location indicated by location information included in ADS-B information broadcast by aircraft B and the predetermined coordinate may be determined as d2. A distance between a location indicated by location information included in ADS-B information broadcast by aircraft C and the predetermined coordinate may be determined as d3. A sum of the second distances may be calculated and obtained as D1. D1 is represented by formula (1).

D1=d1+d2+d3 (1)

where formula (1) is a function between D1 and the predetermined coordinate (x, y, z). The value of the predetermined coordinate when D1 is the smallest may be determined by an algorithm such as a steepest descent method. The value of the predetermined coordinate may be used to indicate the location where the second aircraft is currently located.

In some embodiments, the closer the first aircraft to the second aircraft is, the stronger the signal strength (e.g., signal power) of the first aircraft detected by the second aircraft is. Therefore, a weight may be set for each second distance according to the signal strength of each first aircraft. Thus, the sum of the second distances may be a weighted sum of the second distances. The value of the predetermined coordinate may be determined when the value of the sum is the smallest. The value of the predetermined coordinate may be used to indicate the location where the second aircraft is currently located. Thus, the location of the second aircraft may be closer to a location of a first aircraft having a stronger signal strength (an offset amount being related to the signal strength). As such, the location of the second aircraft may better fit the relationship between the distance and the signal strength to further improve the accuracy of obtaining the location of the second aircraft.

For example, assume that the plurality of first aircrafts may include three first aircrafts, which are identified as aircraft A, aircraft B, and aircraft C. A distance between a location indicated by the location information included in the ADS-B information broadcast by aircraft A and the predetermined coordinate may be determined as d1. A distance between a location indicated by the location information included in the ADS-B information broadcast by aircraft B and the predetermined coordinate may be determined as d2. A distance between a location indicated by the location information included in the ADS-B information broadcast by aircraft C and the predetermined coordinate may be determined as d3. A signal strength of aircraft A detected by the second aircraft may be P1, a signal strength of aircraft B detected by the second aircraft may be P2, and signal strength of aircraft C detected by the second aircraft may be P3. A weight of d1 may be set to P1, a weight of d2 may be set to P2, and a weight of d3 may be set to P3. The weighted sum may be performed on each second distance. The sum is identified as D2. D2 is represented by formula (2).

D2=P1·d1+P2·d2+P3·d3 (2)

where formula (2) may be a function between D2 and the predetermined coordinate (x, y, z). The value of the predetermined coordinate when D2 is the smallest may be determined by an algorithm such as a steepest descent method. The value of the predetermined coordinate may be used to indicate the location where the second aircraft is currently located.

At S204, a first distance between the location indicated by the target location information and the location indicated by the current location information of the second aircraft is calculated. The target location information may include location information included in one piece of ADS-B information.

In some embodiments, when the target location information and the current location information of the second aircraft include location coordinate values, the first distance between the location indicated by the target location information and the location indicated by the current location information of the second aircraft may be calculated and obtained according to a distance formula between two points and coordinate values. When the target location information and the current location information of the second aircraft include longitudes and latitudes of the locations, the longitudes and the latitudes included in the target location information and the current location information of the second aircraft may be converted into coordinate values. The first distance between the location indicated by the target location information and the location indicated by the current location information of the second aircraft may be calculated and obtained according to the distance formula between two points and the coordinate values.

At S205, the current time information of the second aircraft is determined according to the first distance and the target time information. The target time information includes the time information included in the ADS-B information that includes the target location information.

In some embodiments, the second aircraft may determine the time length for transmitting the ADS-B information, i.e., a transmission time of the ADS-B information, according to the first distance and a transmission speed of the ADS-B information. The second aircraft may further determine the current time information of the second aircraft according to the time length for transmitting the ADS-B information and the target time information.

For example, assume that the transmission speed of the ADS-B information is light speed c, the first distance is d4, time indicated by the target time information is T1, and time indicated by the current time information of the second aircraft is T2. Thus, time T2 indicated by the current time information of the second aircraft is represented by formula (3).

$$T 2 = T 1 + \frac{c}{d 4} \qquad ( 3 )$$

In some embodiments, after process S205, the method further includes obtaining a satellite almanac and determining a set of satellite that are visible to the second aircraft (such set is also referred to as a “visible satellite set”) according to the current location information of the second aircraft, the current time information of the second aircraft, and the satellite almanac. The satellite almanac may include location information of a plurality of satellites in a geodetic coordinate system. The visible satellite set may include a plurality of visible satellites. The visible satellite may be a satellite with an elevation angle relative to the second aircraft within a predetermined elevation angle range. The visible satellite may be a satellite in the satellite almanac.

Consistent with the disclosure, the second aircraft may obtain the satellite almanac and determine the set of satellites that are visible to the second aircraft according to the current location information and the current time information of the second aircraft, and the satellite almanac. As such, positioning and/or navigation may be performed on the second aircraft according to the visible satellite set to improve the accuracy of positioning and/or navigation.

In some embodiments, obtaining the satellite almanac can include obtaining the satellite almanac from a satellite signal or obtaining the satellite almanac from a server. The satellite almanac further includes an effective time period of the satellite almanac. The time indicated by the current time information of the second aircraft may be in the effective time period.

Since a satellite moves continuously, the satellite is at different locations at different time points. The second aircraft needs to obtain an effective satellite almanac. In some embodiments, the second aircraft may receive satellite signals transmitted by a plurality of satellites. The second aircraft may obtain the satellite almanac from the satellite signals or download the satellite almanac from the server. Whether the time indicated by the current time information of the second aircraft is in the effective time period of the satellite almanac may be determined. When the time is in the effective time period, the accuracy of the location information of the satellite recorded in the satellite almanac may be high. Thus, the satellite almanac may be determined to be the effective satellite almanac. Otherwise, the accuracy of the location information of the satellite recorded in the satellite almanac may be low. A satellite almanac may need to be obtained again.

In some embodiments, determining the visible satellite set can include determining location information of each satellite in the satellite almanac in the local Cartesian coordinate system according to the satellite almanac and the location information of the second aircraft, determining an elevation angle of each satellite relative to the second aircraft according to the location information of each satellite in the local Cartesian coordinate system, and using the satellite having the elevation angle relative to the second aircraft that is in the predetermined elevation angle range as the visible satellite of the second aircraft to obtain the visible satellite set.

For example, assume that satellite history includes the location information of satellite W in the geodetic coordinate system, that is, a coordinate value (x₀, y₀, z₀) in the geodetic coordinate system. The location information of the second aircraft includes a coordinate value (x₁, y₁, z₁) of the second aircraft in the geodetic coordinate system, and the longitude L₀ and the latitude B₀ of the current location of the second aircraft. The location information of the satellite W in the local Cartesian coordinate system includes a coordinate (xₕ, yₕ, zₕ) in the local Cartesian coordinate system. The coordinate of the satellite W in the local Cartesian coordinate system may be represented by formula (4).

$$[ \begin{matrix}{x}_{h} \\ {y}_{h} \\ {z}_{h}\end{matrix} ] = [ \begin{matrix}- sin {B}_{0} cos {L}_{0} & - sin {B}_{0} sin {L}_{0} & cos {B}_{0} \\ - sin {L}_{0} & cos {L}_{0} & 0 \\ cos {B}_{0} cos {L}_{0} & cos {B}_{0} sin {L}_{0} & sin {B}_{0}\end{matrix} ] \cdot ( [ \begin{matrix}{x}_{0} \\ {y}_{0} \\ {z}_{0}\end{matrix} ] - [ \begin{matrix}{x}_{1} \\ {y}_{1} \\ {z}_{1}\end{matrix} ] ) \qquad ( 4 )$$

Further, the elevation angle of the satellite W relative to the second aircraft may be determined according to the location information of the satellite W in the local Cartesian coordinate system. The elevation angle is denoted by E_{H} and may be represented by formula (5). When the elevation angle is in the predetermined elevation angle range, for example, E_{H} ∈ (0°, 90°], satellite W is determined to be a visible satellite visible to the second aircraft.

E_{H}=arc tg(zₕ/\sqrt{xₕ²+yₕ²}) (5)

In some embodiments, navigation and/or positioning may be performed on the second aircraft according to the current location information and the current time information of the second aircraft, and the satellite almanac.

The second aircraft may perform navigation on the second aircraft according to the current location information and the current time information of the second aircraft, and the satellite almanac, such that the second aircraft may fly to the determined location, and/or perform positioning on the second aircraft according to the current location information of the second aircraft, the current time information, and the satellite almanac, such that accurate location information may be provided to the second aircraft.

In some embodiments, by parsing the ADS-B information broadcast by each of the plurality of first aircrafts, the time information and the location information included in each piece of ADS-B information may be obtained. The current time information of the second aircraft may be determined according to the time information and the location information included in each piece of ADS-B information. Thus, the current time information of the second aircraft may be determined based on the time information and the location information included in the ADS-B information transmitted by the first aircrafts instead of directly using the time information transmitted by the ground terminal as the current time information of the second aircraft, which may increase the accuracy of obtaining the time information of the second aircraft. In addition, the distance between the second aircraft and a first aircraft can be much shorter than the distance between the second aircraft and the ground terminal, which further increases the accuracy of obtaining the time information of the second aircraft. As such, satellite search may be quickly performed according to the time information of the second aircraft.

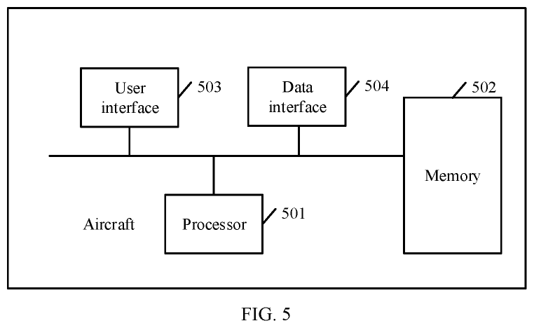

FIG. 5 is a schematic structural diagram of an aircraft according to some embodiments of the present disclosure. In some embodiments, the aircraft includes a processor 501, a memory 502, a user interface 503, and a data interface 504. The data interface 504 may be configured to transmit information, for example, transmit a location request to a satellite. The user interface 503 may be configured to receive a photographing instruction input by the user.

The memory 502 may include a volatile memory, a non-volatile memory, or a combination thereof. The processor 501 may include a central processing unit (CPU). The processor 501 may include a hardware chip. The hardware chip may include an application-specific integrated circuit (ASIC), a programmable logic device (PLD), or a combination thereof. The PLD may include a complex programmable logic device (CPLD), a field-programmable gate array (FPGA), or a combination thereof.

In some embodiments, the aircraft may further include a gimbal, a handle, and a camera device. The camera device is carried by the gimbal. The gimbal is arranged at the handle. The handle is configured to control the rotation of the gimbal to control the camera device to photograph.

In some embodiments, the memory 502 may store a program instruction. The processor 501 may call the program instruction stored in the memory 502 to receive ADS-B information broadcast by each of a plurality of first aircrafts, parse each piece of ADS-B information to obtain location information and time information included in each piece of ADS-B information, and determine current time information of a second aircraft according to the location information and the time information included in each piece of ADS-B information.

In some embodiments, the memory 502 may store the program instruction. The processor 501 may call the program instruction stored in the memory 502 to determine the current location information of the second aircraft according to the location information included in each piece of ADS-B information, calculate a first distance between the location indicated by the target location information and the location indicated by the current location information of the second aircraft, and determine the current time information of the second aircraft according to the first distance and the target time information. The target location information includes location information included in one piece of ADS-B information. The target time information includes time information included in the ADS-B information that includes the target location information.

In some embodiments, the memory 502 may store the program instruction. The processor 501 may be configured to call the program instruction stored in the memory 502 to calculate the second distance between the location indicated by the location information included in each piece of ADS-B information and the predetermined coordinate, calculate the sum of the second distances, and determine the value of the predetermined coordinate when the sum is the smallest. The predetermined coordinate value is used to indicate the current location of the second aircraft.

In some embodiments, the memory 502 may store the program instruction. The processor 501 may be configured to call the program instruction stored in the memory 502 to obtain the satellite almanac and determine the set of satellites that are visible to the second aircraft according to the current location information of the second aircraft, the current time information of the second aircraft, and the satellite almanac. The satellite almanac may include location information of a plurality of satellites in the geodetic coordinate system. The visible satellite set may include a plurality of visible satellites. The visible satellite may be a satellite with an elevation angle relative to the second aircraft in the predetermine elevation angle range. The visible satellite may be a satellite in the satellite almanac.

In some embodiments, the memory 502 may store the program instruction. The processor 501 may be configured to call the program instruction stored in the memory 502 to perform navigation and/or positioning on the second aircraft according to the current location information of the second aircraft, the current time information of the second aircraft, and the satellite almanac.

In some embodiments, the memory 502 may store the program instruction. The processor 501 may be configured to call the program instruction stored in the memory 502 to obtain the satellite almanac from the satellite signal or the server. The satellite almanac further includes the effective time period of the satellite almanac. Time indicated by the current time information of the second aircraft is in the effective time period.

In some embodiments, the memory 502 may store the program instruction. The processor 501 may be configured to call the program instruction stored in the memory 502 to determine the location information of each satellite of the satellite almanac in the local Cartesian coordinate system according to the satellite almanac and the location information of the second aircraft, determine the elevation angle of each satellite relative to the second aircraft according to the location information of each satellite in the local Cartesian coordinate system, and use the satellite having the elevation angle relative to the second aircraft that is in the predetermine elevation angle range as the visible satellite of the second aircraft to obtain the visible satellite set.

Embodiments of the present disclosure further provide a computer-readable storage medium. The computer-readable storage medium stores a computer program that, when executed by the processor, causes the processor to implement the image processing method described in embodiments corresponding to FIG. 2, FIG. 3, or FIG. 4 of the present disclosure and the aircraft of embodiments corresponding to FIG. 5, which is not repeated here.

The computer-readable storage medium may include an internal storage unit of the apparatus described in embodiments of the present disclosure, such as a hard disk or internal memory of the apparatus. The computer-readable storage medium may also include an external storage device of the apparatus, such as a plug-in hard disk, a smart memory card (SMC), or a secure digital (SD) card, a flash card, etc., equipped on the apparatus. Further, the computer-readable storage medium may also include both the internal storage unit of the apparatus and the external storage device. The computer-readable storage medium may store the computer program and another program and data required by the terminal. The computer-readable storage medium may further temporarily store data that has been output or will be output.

Those of ordinary skill in the art can understand that all or part of the processes in the methods of embodiments of the present disclosure may be implemented by instructing relevant hardware through a computer program. The program may be stored in the computer-readable storage medium. The program, when executed by the processor, causes the processor to execute flows of method embodiments. The storage medium may include a magnetic disk, an optical disc, a read-only memory (ROM), or a random access memory (RAM), etc.

Only some embodiments of the present disclosure are described above and should not be used to limit the claims of the present invention. Therefore, equivalent changes made according to the claims of the present invention are still within the scope of the present invention.

What is claimed is:

1. An information processing method comprising:
receiving one or more pieces of automatic dependent surveillance-broadcast (ADS-B) information each broadcast by one of one or more first aircrafts;
parsing the one or more pieces of ADS-B information to obtain one or more pieces of parsed location information and one or more pieces of parsed time information, each of the one or more pieces of parsed location information and each of the one or more pieces of parsed time information corresponding to one of the one or more first aircrafts; and
determining current time information of a second aircraft according to the one or more pieces of parsed location information and the one or more pieces of parsed time information.

2. The method of claim 1, wherein determining the current time information of the second aircraft according to the one or more pieces of parsed location information and the one or more pieces of parsed time information includes:
determining current location information of the second aircraft according to the one or more pieces of parsed location information;
calculating a distance between a location indicated by target location information and a location indicated by the current location information of the second aircraft, the target location information being one of the one or more pieces of parsed location information; and
determining the current time information of the second aircraft according to the distance and target time information, the target time information being one of the one or more pieces of parsed time information, and the target time information and the target location information being included in a same one of the one or more pieces of ADS-B information.

3. The method of claim 2, wherein:
the distance is a first distance; and
determining the current location information of the second aircraft according to the one or more pieces of parsed location information includes:
calculating one or more second distances each being between a coordinate and a location indicated by one of the one or more pieces of parsed location information;
calculating a sum of the one or more second distances; and
determining a value of the coordinate that minimizes the sum, the value of the coordinate that minimizes the sum indicating a location where the second aircraft is currently located.

4. The method of claim 2, further comprising:
obtaining a satellite almanac including location information of a plurality of satellites in a geodetic coordinate system; and
determining a visible satellite set according to the current location information of the second aircraft, the current time information of the second aircraft, and the satellite almanac, the visible satellite set including one or more visible satellites from the plurality of satellites, and each of the one or more visible satellites having an elevation angle relative to the second aircraft in a predetermined elevation angle range.

5. The method of claim 4, further comprising:
performing at least one of navigation or positioning for the second aircraft according to the location information of the second aircraft, the time information of the second aircraft, and the satellite almanac.

6. The method of claim 4, wherein:
obtaining the satellite almanac includes obtaining the satellite almanac from a satellite signal or a server; and
the satellite almanac includes an effective time period of the satellite almanac, a time indicated by the current time information of the second aircraft being in the effective time period.

7. The method of claim 6, wherein determining the visible satellite set includes, for each of the plurality of satellites in the satellite almanac:
determining location information of the satellite in a local Cartesian coordinate system according to the satellite almanac and the location information of the second aircraft;
determining an elevation angle of the satellite relative to the second aircraft according to the location information of the satellite in the local Cartesian coordinate system; and
in response to the elevation angle of the satellite relative to the second aircraft being in the predetermined elevation angle range, determining that the satellite is one of the one or more visible satellites.

8. A computer-readable storage medium storing a computer program that, when executed by a processor, causes the processor to perform the method of claim 1.

9. An aircraft comprising:
a vehicle body;
a propulsion system arranged at the vehicle body and configured to provide flight power;
a camera device arranged at the vehicle body and configured to perform at least one of photographing or video recording; and
a processor configured to:
receive one or more pieces of automatic dependent surveillance-broadcast (ADS-B) information each broadcast by one of one or more reference aircrafts;
parse the one or more pieces of ADS-B information to obtain one or more pieces of parsed location information and one or more pieces of parsed time information, each of the one or more pieces of parsed location information and each of the one or more pieces of parsed time information corresponding to one of the one or more reference aircrafts; and
determine current time information of the aircraft according to the one or more pieces of parsed location information and the one or more pieces of parsed time information.

10. The aircraft of claim 9, wherein the processor is further configured to:
determine current location information of the aircraft according to the one or more pieces of parsed location information;
calculate a distance between a location indicated by target location information and a location indicated by the current location information of the aircraft, the target location information being one of the one or more pieces of parsed location information; and
determine the current time information of the aircraft according to the distance and target time information, the target time information being one of the one or more pieces of parsed time information, and the target time information and the target location information being included in a same one of the one or more pieces of ADS-B information.

11. The aircraft of claim 10, wherein:
the distance is a first distance; and
the processor is further configured to:
calculate one or more second distances each being between a coordinate and a location indicated by one of the one or more pieces of parsed location information;
calculate a sum of the one or more second distances; and
determine a value of the coordinate that minimizes the sum, the value of the coordinate that minimizes the sum indicating a location where the aircraft is currently located.

12. The aircraft of claim 10, wherein the processor is further configured to:
obtain a satellite almanac including location information of a plurality of satellites in a geodetic coordinate system; and
determine a visible satellite set according to the current location information of the aircraft, the current time information of the aircraft and the satellite almanac, the visible satellite set including one or more visible satellites from the plurality of satellites, and each of the one or more visible satellites having an elevation angle relative to the aircraft in a predetermined elevation angle range.

13. The aircraft of claim 12, wherein the processor is further configured to:
perform at least one of navigation or positioning for the aircraft according to the location information of the aircraft, the time information of the aircraft, and the satellite almanac.

14. The aircraft of claim 12, wherein:
the processor is further configured to obtain the satellite almanac from a satellite signal or a server; and
the satellite almanac includes an effective time period of the satellite almanac, a time indicated by the current time information of the aircraft being in the effective time period.

15. The aircraft of claim 14, wherein the processor is further configured to:
determine location information of the satellite in a local Cartesian coordinate system according to the satellite almanac and the location information of the aircraft;
determine an elevation angle of the satellite relative to the aircraft according to the location information of the satellite in the local Cartesian coordinate system; and
in response to the elevation angle of the satellite relative to the aircraft being in the predetermined elevation angle range, determine that the satellite is one of the one or more visible satellites.

16. An aircraft system comprising:
one or more first aircrafts configured to generate and broadcast one or more pieces of automatic dependent surveillance-broadcast (ADS-B) information each from one of the one or more first aircrafts; and
a second aircraft configured to:
receive the one or more pieces of ADS-B;
parse the one or more pieces of ADS-B information to obtain one or more pieces of parsed location information and one or more pieces of parsed time information, each of the one or more pieces of parsed location information and each of the one or more pieces of parsed time information corresponding to one of the one or more first aircrafts; and
determine current time information of a second aircraft according to the one or more pieces of parsed location information and the one or more pieces of parsed time information.

17. The aircraft system of claim 16, wherein the second aircraft is further configured to:
determine current location information of the second aircraft according to the one or more pieces of parsed location information;
calculate a distance between a location indicated by target location information and a location indicated by the current location information of the second aircraft, the target location information being one of the one or more pieces of parsed location information; and
determine the current time information of the second aircraft according to the distance and target time information, the target time information being one of the one or more pieces of parsed time information, and the target time information and the target location information being included in a same one of the one or more pieces of ADS-B information.

18. The aircraft system of claim 17, wherein:
the distance is a first distance;; and
the second aircraft is further configured to:
calculate one or more second distances each being between a coordinate and a location indicated by one of the one or more pieces of parsed location information;
calculate a sum of the one or more second distances; and
determine a value of the coordinate that minimizes the sum, the value of the coordinate that minimizes the sum indicating a location where the second aircraft is currently located.

19. The aircraft system of claim 17, wherein the second aircraft is further configured to:
obtain a satellite almanac including location information of a plurality of satellites in a geodetic coordinate system; and
determine a visible satellite set according to the current location information of the second aircraft, the current time information of the second aircraft, and the satellite almanac, the visible satellite set including one or more visible satellites from the plurality of satellites, and each of the one or more visible satellites having an elevation angle relative to the second aircraft in a predetermined elevation angle range.

20. The aircraft system of claim 19, wherein the second aircraft is further configured to:
perform at least one of navigation or positioning for the second aircraft according to the location information of the second aircraft, the time information of the second aircraft, and the satellite almanac.
